(19) United States
(12) Patent Application Publication
(10) Pub. No.: US 2001/0047755 A1
(43) Pub. Date: Dec. 6, 2001

(54) Method and configuration for transporting electrically conductive paint

(76) Inventors: Joachim Lichte, Rockenberg-Ot Oppertshofen (DE); Thomas Borner, Butzbach (DE)

Correspondence Address: LERNER AND GREENBERG, P.A., Post Office Box 2480, Hollywood, FL, 33022-2480, US

(21) Appl. No.: 09/843,515

(22) Filed: Apr. 26, 2001

Related U.S. Application Data
(63) Continuation of application No. PCT/EP00/08255, filed on Aug. 24, 2000.

(30) Foreign Application Priority Data
Aug. 26, 1999 (DE) 199 40 542.5

(51) Int. Cl. B05C 11/00

(52) U.S. Cl. 118/704

(57) ABSTRACT

A method and a configuration are provided for transporting electrically conductive paint from a point at ground potential to at least one paint application device which is at a high voltage potential. A given quantity of a given paint is put into a cartridge at the point at ground potential, which is used as a loading station. The cartridge is then conveyed pneumatically through an at least partly electrically insulated pipe system to the at least one paint application device and is connected to a spray head provided there. The cartridge, which is completely or partly emptied after the painting operation, is conveyed pneumatically back to the point at ground potential, while at least one further cartridge is being filled there. Following the receipt of the completely or partly emptied cartridge, a further cartridge is then conveyed to the at least one paint application device.

### CROSS-REFERENCE TO RELATED APPLICATION

This application is a continuation of copending International Application No. PCT/EP00/08255, filed Aug. 24, 2000, which designated the United States.

### BACKGROUND OF THE INVENTION:

1. Field of the Invention

The invention relates to a method and a configuration for transporting electrically conductive paint.

Painting methods are used in an extremely wide range of configurations when many identical work pieces, for example car bodies in automobile manufacturing, have to be painted. The painting methods are automated to the greatest possible extent, in order to achieve the highest possible throughput of workpieces. Conventional conveying speeds in automobile manufacturing on a production line are 2.5 m/s to 10 m/s. To this end, it is necessary to carry out a color change within 10 to 15 seconds in these painting methods.

In order to be able to meet such time constraints for a color change, the different colors are normally pumped around from a paint tank in a ring line in each case. From these ring lines, branch lines lead to a battery of valves frequently equipped as a color-change block, which then selects the chosen color and feeds the paint to a line which is connected to the paint application device. In order to shorten the times for a color change further, the battery of valves and the line to the painting device are provided in duplicate and installed in such a way that they can be operated in parallel. The color-change block is provided as close as possible to the paint application device, in order to configure the branch lines in which the color may also sit for a relatively long time, that is to say, cannot be pumped around, to be as short as possible.

Color tanks and paint application device are normally provided physically far from one another. Accordingly, the ring lines between the color tank and the paint application device are often very long.

In such methods, the number of colors is restricted to normally 25 colors, since for each color a circulation line is installed and the installation outlay for further colors, which are then often also used less frequently, is no longer justified economically.

A further aspect is that during the color change there are paint losses, in particular as a result of the cleaning of the paint line between the color-change block and the paint application device, which is done before the next paint of a different color is led into the paint line. In order to minimize such paint losses, in recent times so-called scrapers or “pigs” have been used. These force the greatest possible volume of paint in the paint line back into the associated branch line for the relevant color, before the cleaning of the paint line is carried out.

The workpieces to be painted are often transported to a painting area by a conveying device and, after the painting operation, are transported out of this area again. The painting operation can also be carried out during the transport within a specific area, so that the workpieces to be painted are moved continuously.

Consequently, the painting areas are configured in different ways and provided with different paint application devices. For example, the painting area can be configured as a stationary painting cubicle. An example of a paint application device is a paint atomizer. In addition, stationary painting robots with a paint atomizer moved by the robot are also used as a paint application device. In addition, painting robots which travel along in the painting area are also used as a paint application device.

Depending on the requirement, the paint or lacquer has to be applied in layers in a number of steps, and to some extent, the different paints are also applied one above another, for example firstly a primer, then a colored paint or lacquer and finally a clear lacquer as a topcoat. The layers are then normally applied by the appropriate paint application devices in successive painting areas and baked on in drying ovens.

In addition, the painting technique used differs significantly, depending on the given boundary conditions. Initially, predominantly paints based on solvents were used. Since these paints have only a low electrical conductivity, high-voltage methods with a so-called direct charging are often used here. The painting device, including the paint in the painting area, is in this case placed under a high voltage of up to 50 kV, so that the atomized paint particles carry an electrical charge. The workpiece to be painted is connected to ground potential. The paint particles are therefore attracted by the workpiece to be painted, as a result of the electrical attraction force, and in this way the utilization of paint is considerably increased.

In the case of painting with modern, environmentally friendly water-based paints, direct charging with high voltage is not possible, since the water-based paints are electrically conductive, and the high voltage would be dissipated via the paint. However, in order to increase the utilization of paint through the use of direct high-voltage charging here too, the supply of paint has to be isolated electrically from the painting device. If this is not possible, the charging of the paint particles can also be achieved to some extent through the use of so-called external charging electrodes. Only in flight are the paint particles charged up in the electrical field between the electrodes and the workpiece. The insulating effect of the air prevents a high-voltage discharge taking place via the water-based paint.

### SUMMARY OF THE INVENTION

It is accordingly an object of the invention to provide a method and a configuration for transporting electrically conductive paint which overcome the above-mentioned disadvantages of the heretofore-known methods and configurations of this general type and which provide an improved supply of electrically conductive paint to the paint application device while taking into account the necessary high-voltage isolation and without requiring restrictions with regard to paint quality and the color variety.

With the foregoing and other objects in view there is provided, in accordance with the invention, a method of transporting electrically conductive paint, that includes the steps of:

filling a required quantity of an electrically conductive paint into a cartridge at a location at ground potential, the location at ground potential serving as a loading station;

pneumatically conveying the cartridge filled with the electrically conductive paint through an at least partly electrically insulating pipe system to a paint application device at a high potential;

connecting, at the paint application device, the cartridge to a spray head provided at the paint application device;

pneumatically conveying the cartridge back to the location at ground potential, when the cartridge is at least partly emptied;

filling a further cartridge at the location at ground potential; and

subsequent to receiving an at least partly emptied cartridge at the location at ground potential, conveying the further cartridge to the paint application device.

A preferred mode of the invention includes the steps of filling the further cartridge at the location at ground potential and simultaneously pneumatically conveying the cartridge back to the location at ground potential, when the cartridge is at least partly emptied.

Another mode of the invention includes the steps of providing a further paint application device, the paint application device and the further paint application device having respectively different addresses and being connected to the at least partly electrically insulating pipe system, conveying filled cartridges from the loading station to the paint application device and the further paint application device, and conveying at least partly emptied cartridges from the paint application device and the further paint application device back to the loading station.

A further mode of the invention includes the steps of filling cartridges at at least two loading stations and providing each of the cartridges with a respective unique address, providing a further paint application device, the paint application device and the further paint application device having respectively different addresses and being connected to the at least, partly electrically insulating pipe system, conveying filled cartridges from the at least two loading stations to the paint application device and the further paint application device, and conveying at least partly emptied cartridges from the paint application device and the further paint application device back to the at least two loading stations.

With the objects of the invention in view there is also provided, a configuration for transporting electrically conductive paint, including:

a loading station configured for loading cartridges to be used for transporting paint, the loading station being a location at ground potential;

a paint application device at a high potential;

a pipe system connected to the location at ground potential and to the paint application device, the pipe system being at least partly configured as an electrically insulating system;

a compressed-air conveying device for pneumatically conveying the cartridges; and

an electronic control device, operatively connected to at least one of the loading station and the paint application device, for at least partly controlling a paint transport.

A preferred embodiment of the invention includes a further paint application device at a high potential, the pipe system has a connection end and a pipe branch with ends, the loading station is connected to the connection end of the pipe system, and the paint application device and the further paint application device are connected to the ends of the pipe branch.

Another embodiment of the invention includes a further paint application device at a high potential, the pipe system is a ring line having pipe branches with ends, and the loading station, the paint application device, and the further paint application device are connected to the ends of the pipe branches.

A further embodiment of the invention includes a further paint application device at a high potential, the pipe system includes two pipelines having respective first ends and respective second ends, the loading station is connected to the first ends of the two pipelines, and the paint application device and the further paint application device are respectively connected to the second ends of the two pipelines.

The pipe system is for example a pipeline configured as a one-piece-pipeline between the loading station and the paint application device.

According to another feature of the invention, the pipe system includes a pipeline configured as a one-piece-pipeline between the loading station and the pipe branch.

According to a further feature of the invention, the loading station has a loading place connected to the pipe system and devices for filling the cartridges with paint, for pneumatically dispatching the cartridges, for receiving at least partly emptied cartridges, and for moving the at least partly emptied cartridges from the loading place.

A further embodiment of the invention includes a further loading place identical to the loading place, the loading place and the further loading place are selectively operable in parallel and independently of one another.

Another embodiment of the invention includes further paint application devices, the loading station has a given number of identical loading places, the given number corresponds to a total number of the paint application devices, and the loading places are selectively operable in parallel or independently of one another.

According to another feature of the invention, the loading station has devices for storing filled cartridges, for sorting filled cartridges, for cleaning at least partly emptied cartridges, for testing cartridges for damage, for conveying residual paint back into an associated line, and for one of rotating and moving cartridges in order to prevent sedimentation of the paint.

According to another feature of the invention, the paint application device has a receiving station with at least one place connected to the pipe system, and devices for receiving filled cartridges, for metering paint, for guiding paint through a line system to a spray head, and for pneumatically dispatching at least partly emptied cartridges.

According to yet another feature of the invention, the receiving station has two places connected to the pipe system such that the two places can be operated independently of one another.

According to a further feature of the invention, the paint application device additionally has devices for storing cartridges, for refilling cartridges with residual paint, and for one of rotating and moving cartridges in order to prevent sedimentation of the paint.

According to another feature of the invention, the pipe system includes pipes, at least some of the pipes are formed of an electrically insulating material.

According to another feature of the invention, the pipe system includes at least a first pipe formed of an electrically insulating material and connected to the paint application device at the high potential, and the pipe system includes at least a second pipe made of a metallic material.

According to a further feature of the invention, the pipe system has inner surfaces configured for spinning the cartridges when being conveyed through the pipe system for preventing sedimentation of the paint.

According to another feature of the invention, the electronic control device is an automatic control device for coordinating a paint selection, color sequences, and operations of at least one of the loading station and the paint application device, and the compressed-air conveying device.

According to yet another feature of the invention, the electronic control device operates based on a fuzzy logic.

According to another feature of the invention, the electronic control device takes into account service lives or “pot lives” of paints of different colors in respective cartridges and optimizes an operation sequence based on the service lives.

According to a further feature of the invention, the electronic control device is a component in an overall control device for supplying the paint.

According to yet a further feature of the invention, the electronic control device is configured for performing an overall control.

According to another feature of the invention, the electronic control device learns and adapts parameters automatically based on operating data collected and evaluated during an operating time.

With the objects of the invention in view there is also provided, a configuration for transporting electrically conductive paint, including:

cartridges for transporting paint, the cartridges having respective pistons, the pistons being movable to respective positions in the cartridges for matching respective paint volumes in the cartridges;

a loading station configured for loading the cartridges, the loading station being a location at ground potential;

a paint application device at a high potential;

a pipe system connected to the location at ground potential and to the paint application device, the pipe system being at least partly configured as an electrically insulating system;

a compressed-air conveying device for pneumatically conveying the cartridges; and

an electronic control device, operatively connected to at least one of the loading station and the paint application device, for at least partly controlling a paint transport.

According to the invention, at a point at ground potential (earth potential), the paint to be transported is put into cartridges with an integrated piston, which is guided in the respective cartridge and is matched to the volume of paint present or desired. This area around this point or location will be referred to below as a loading station, since, in addition to a device for filling cartridges, it may have still further devices which help to favorably configure the method sequence. The loading station is advantageously provided in or close to a color-mixing room. As a result, the so-called circulation lines, in which paint circulates between paint tank and color-change block, are advantageously short for paint of the different colors, a color change can be carried out simply, and the flushing of the ring line is simplified and shortened and flushing agent is saved. The number of possible colors is not restricted by the transport method of the paint. The cartridge therefore avoids paint having to be pumped around continuously in long ring lines, since pumping around damages the paint quality and continuously needs power for the pumps. The size of the cartridge or its degree of filling is matched to the painting task, so that only comparatively small paint volumes are used and moved. This reduces paint losses in the event of contamination, the safety risk in the case of leakages is correspondingly low, and the material investment in the filling volumes is particularly low.

According to the invention, paint of a selected hue or color is first put into a cartridge in a device belonging to the loading station, and moved into a further device for sending and/or receiving the cartridge, the loading station being connected to a pipe system for a pneumatic transport. In the simplest case, the pipe system includes a pipeline to a paint application device which has a receiving station for cartridges. Since high-voltage methods with direct charging are preferably used when painting, the paint application device and the electrically conductive parts conductively connected to it, for example the supply lines are from time to time at high voltage. In order to avoid disruption and hazards caused by this, the pipe system is fabricated, completely or at least partly, from electrically insulating material, for example from plastics such as PVC (polyvinyl chloride). This achieves electrical isolation between paint application device and paint conveying system in an effective manner.

The cartridge is then moved pneumatically through the pipe system until it has arrived in the receiving station of the paint application device. The compressed air for pneumatic conveyance can either be taken from an existing factory network or is generated and fed in centrally or decentrally for the different conveying operations of the method. The compressed air for the conveying operation usually already acts on the cartridge in the loading station, but it is also conceivable for the compressed air to act only in the pipe system and, consequently, for the cartridge to first be moved into the pipe system through the use of a mechanically, electrically, pneumatically or hydraulically operated drive.

The receiving station of the paint application device receives the filled cartridge and supplies it for use in other devices, for example in a metering device, which generally meters the paint by volume and guides it to the atomizer or atomizers or spray heads present.

In the ideal case, the paint is completely consumed by the painting. Otherwise, a paint residue remains in the cartridge, or paint residues in lines are put back into the cartridge again by a device, for example a scraper device or “pig,” belonging to the paint application device. The cartridge therefore emptied or partly emptied is then moved back pneumatically from the receiving station through the pipe system to the loading station. For this purpose, the receiving station is equipped with an appropriate compressed-air supply, or is supplied with compressed air in a manner comparable with a loading station. Once it has arrived in the loading station, the empty or partly emptied cartridge is moved from the receiving device, in order to provide space for a next cartridge with paint, which is then moved into this device, so that the first method step can be executed again.

If the shortest possible times between the dispatch of individual cartridges are to be achieved, or cartridges are to be dispatched to different paint application devices, both the method according to the invention and the configurations for implementing the method according to the invention can advantageously be configured in accordance with the painting task. This is to be carried out on the basis of the following examples, with the particular advantages being explained.

For example, it is often the case that one loading station has to supply more than one paint application device with paint. In this case, the pipe system is connected on the one hand to the loading station, and, on the other side the pipe system branches, for example through the use of pipe diverters, to the different paint application devices and is connected to the associated receiving stations. Each of the paint application devices and receiving stations is given an address for this purpose. If, then, a cartridge with paint is to be dispatched, the loading station first of all selects the address of the receiving station to which the cartridge with paint is to be dispatched. According to this address, the pipe system is set by a control device, for example by setting the pipe diverters, and also the cartridge is moved pneumatically and accurately to the addressed receiving station of the paint application device. The selection of the address or the addressing sequence can be carried out in accordance with a predefined plan, but also on the basis of an appropriate request from a receiving station or the paint application device for a filled cartridge of a specific color.

An advantageously simple configuration of a loading station has a loading place for cartridges, at which a cartridge with paint is moved into an associated compartment. From the loading place, the cartridge can then be moved pneumatically through the pipe system. If the compartment has no cartridge and is ready to receive, an empty cartridge from a receiving station, for example, can be received from the pipe system and subsequently moved out of the compartment.

In order to shorten the replacement of filled and empty cartridges in the loading place of the loading station, the loading place is advantageously configured in such a way that there are at least two compartments for cartridges. This means that the loading station can carry out at least two of its functions simultaneously. For example, a filled cartridge is inserted into a first compartment while a second compartment is ready to accommodate an empty cartridge. If an empty cartridge has arrived in the second compartment, it is again possible, as a result of the filled cartridge being moved into the loading station, for the empty cartridge to be simultaneously moved out of the loading station.

A further advantageous configuration for increasing the capacity of the loading station is achieved by setting up at least two loading places. By operating the loading places independently of one another or in parallel, the loading station can dispatch or receive more cartridges more quickly.

It is also in accordance with the idea of the invention if further functions are performed by the loading station, and there are corresponding devices at the loading station. In addition to the basic tasks, such as loading, sending, receiving, changing and unloading a cartridge, the loading station is advantageously also configured for filling, testing, replacing faulty cartridges, storing or magazining, sorting, rotating or moving in order to prevent the sedimentation of the paint, and for flushing cartridges. If the respective devices are provided jointly for all loading places, this leads to an advantageous, compact configuration of the loading station and therefore to a lower requirement for space for the system overall.

However, one or more of these devices may also be present separately for each loading place.

The number of compartments per loading place is adapted to the devices present such that an optimum process sequence is achieved.

In order to shorten the process times, a simple receiving station of a paint application device, which has a space with a compartment for a cartridge, is advantageously equipped with at least two compartments for cartridges and in this way, for example, provides a cartridge in a first compartment for painting for the paint application device, while another compartment is positioned to receive a filled cartridge.

The receiving station is configured, by equipping with further devices and increasing the number of compartments, such that it fulfils the functions of receiving, storing or magazining, emptying, sending, rotating and/or moving a cartridge and of metering the paint, and if required can also carry out all or some of the functions at the same time.

In the simplest conceivable case, the pipe system is a pipe between a loading station and a paint application device. If a number of paint application devices or loading stations are to be connected by the pipe system, there are a number of possibilities for implementing this. For example, the pipe system, beginning as a pipe from a loading station, can branch to the paint application devices. However, the pipe system can also be configured as a ring line, and the paint application devices and the loading stations are connected to the ring pipe by branches for inserting and removing the cartridges.

It is advantageous if, as a result of the configuration of the pipes, a cartridge is imparted a left-hand or right-hand spin as it moves through them. The paint then remains homogeneous and maintains its structure. In particular, it is possible to apply to the inner surface of the pipe a surface structure which produces the spin described.

A control device coordinates the individual method steps in a simple case through the use of a defined control sequence. Furthermore, for example, control signals from other control devices are processed, for example from the conveying device of the workpieces or a system which sets the color sequence.

The control task is particularly advantageously carried out by a control device which is based on fuzzy logic. In particular if the control device has to fulfil particularly complex tasks, a fuzzy logic control system is used instead of a previously conventional control system using numerical values based on differential equations for physical relationships. This is the case, for example, when the service time, similar to a “pot life” of the paints also has to be taken into account by the control device. This depends, inter alia, on the color, the specific cartridge, the frequency with which the specific cartridge has been used, etc. These parameters are registered and assessed by the fuzzy-logic control device, and then those cartridges which are close to the end of their service time are preferably used, or cartridges which have exceeded their service time are fed to the cleaning step.

Other features which are considered as characteristic for the invention are set forth in the appended claims.

Although the invention is illustrated and described herein as embodied in a method and a configuration for transporting electrically conductive paint, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1 is a block diagram of a pneumatic transport system for paint with one loading station according to the invention, and

FIG. 2 is a block diagram of a pneumatic transport system for paint with two loading stations according to the invention;

FIG. 3 is a block diagram of a transport system with a branched pipe system according to the invention; and

FIG. 4 is a block diagram of a transport system with a ring pipe system according to the invention.

### DESCRIPTION OF THE PREFERRED EMBODIMENTS

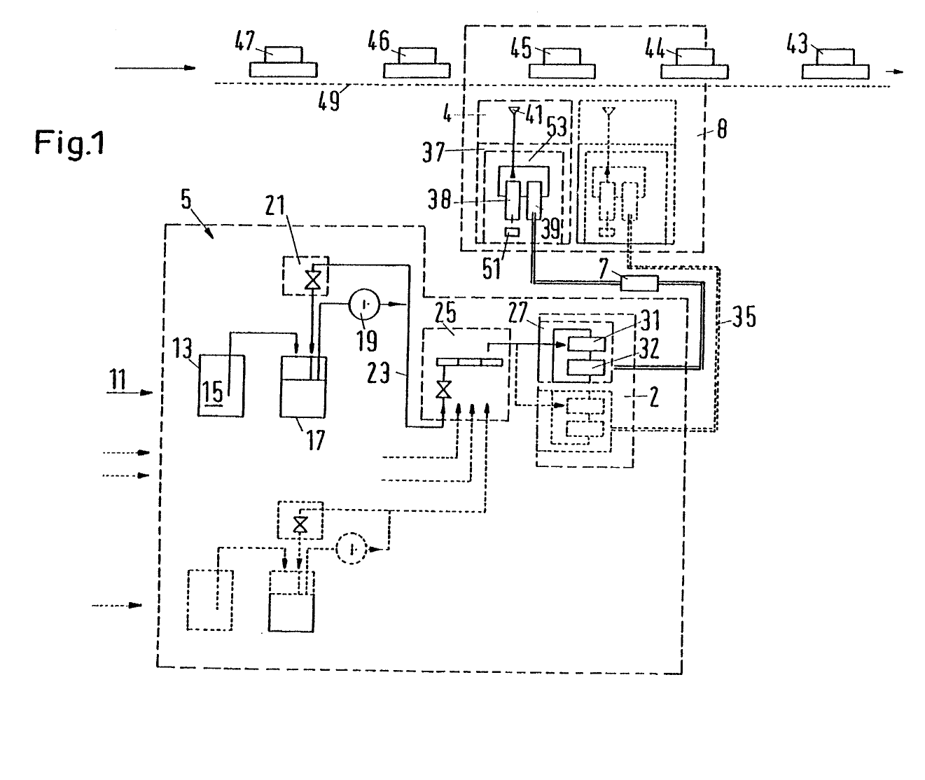

Referring now to the figures of the drawings in detail and first, particularly, to FIG. 1 thereof, there is shown a schematic diagram of a possible configuration of a configuration of a pneumatic transport system for paint for painting car bodies. The delivery 11 of paint is carried out in containers 13 containing paint of different colors 15. The paints delivered are taken from the containers 13 into the circulation tanks 17 allocated to the colors 15 and firstly stored there. In each case a short circulation line is connected to each of these circulation tanks 17. The stored paint is conveyed out of the respective circulation tank 17 as required through the use of a pump 19 allocated to each circulation line, and is pumped through the circulation line, via a throttling element or valve element 21 in the circulation line, back into the same circulation tank 17.

From each of the circulation lines, a branch line 23 leads to a color-change block 25, which, on the inlet side, has at least as many shut-off elements as there are branch lines connected. On the outlet side, the color-change block 25 is connected by a line to a loading station 2. The containers 13, the circulation tanks 17, the color-change block 25, the loading station 2 and the associated pipelines and other parts of the system and components are provided in a color-mixing room 5. The loading station 2 has a number of identical loading places 27, which corresponds to the number of paint application devices 4 present. The loading place 27 has two identical loading compartments 31, 32. Each of the loading places 27 is connected by a pipeline to the paint supply through the color-change block 25. One of the loading compartments 32 is located precisely in a position at which it is connected to a pipe system 35 which, with one pipeline in each case, leads from one of the loading places 27 to an associated paint application device 4. The loading compartments 31, 32 are, for example, provided in a circle in their loading places 27, so that the positions of the compartments 31, 32 and therefore also of the cartridges 7 located therein are moved with one movement step. The pipes in the pipe system 35 are configured in such a way that a cartridge 7 is moved through them without difficulty. The paint application devices 4 each have a receiving station 37, which are each equipped with two compartments 38, 39. In the respective first compartment 38 there is a metering device for paint, which conveys the paint, preferably volumetrically, out of a cartridge 7 which is present there, forces it into a paint line and conveys it through the latter to a spray head 41. The paint application devices 4 are provided in a high-voltage area 8 in such a way that the workpieces to be painted, specifically car bodies 43, 44, 45, 46, 47 are transported on a conveyor system 49 into the high-voltage area 8, past the paint application devices 4 and out of the high-voltage area 8 again. The compartments 38, 39 are each provided in the manner of a paternoster in the associated receiving stations 37 such, that all the positions of the compartments 38, 39 can be moved onwards with one movement step of the receiving station 37, and therefore the cartridges 7 which are present there are moved along at the same time.

The configuration illustrated in the schematic diagram of FIG. 1 performes the following method steps. Paint of different colors 15 is delivered into the color-mixing room 5 in containers 13. Firstly, the paints are transferred from the containers 13 into the associated circulation tanks 17. Emptied containers 13 are then taken out of the color-mixing room 5, in order to provide space for possible new deliveries 11 of further containers 13. If then, a specific color 15 is requested by a paint application device 4, a control device coordinates the following for this color 15. The pump 19 is switched on and the throttling element 21 is opened, so that the paint of this color 15 is pumped around in the corresponding circulation line. The color-change block 25 then opens its shut-off valve allocated to this color, so that the paint passes through the color-change block 25 and through the line leading onwards to the loading places 27 of the loading station 2. The loading places 27 are configured such that they put the paint into a cartridge 7 in a first position, the filling position. For example, the first loading compartment 31 of the loading place 27 is located in the filling position. There, the paint is then put into a new or cleaned cartridge 7, if there is one in the loading compartment 37, and if there is a corresponding paint request from the associated paint application device 4. Once the cartridge 7 has been filled in the loading compartment 31, the latter is moved to a second position, the dispatch position of the loading place 27, and at the same time the second loading compartment 32 is moved into the filling positions. The filled cartridge 7 is now in the dispatch position of the loading place 27, to which a pipeline belonging to the pipe system 35 is connected, while the second loading compartment 32 is located in the filling position of the loading place 27. From the dispatch position, the filled cartridge 7 is moved pneumatically to the associated receiving station 37. The now empty loading compartment 31 waits until a cartridge 7 is sent back from the receiving-station 37. A similar procedure applies to the other loading stations 27. If, according to the requirement, the cartridges 7 in all the loading compartments 31, have been filled with the color 15, and all the loading compartments 31 have been moved from the filling position into the dispatch position, a color change can be carried out in the paint supply of the system, and a new color 15 according to a following request is conveyed from the appropriate color tank 17 to the loading station 2. If a further workpiece is painted in sequence with the color 15 last used, the color change is omitted and a further cartridge is filled with the color 15 present in the paint supply. The loading compartment 31 then contains a cartridge 7 which has been sent back, leaves the dispatch position of the loading place 27 and is moved back to the filling position. The cartridge 7 sent back is moved out of the loading compartment 31, and a new or cleaned cartridge is introduced into the loading compartment 31 and the filling of the new cartridge 7 with the following color begins.

A filled cartridge 7 is accepted from the receiving station 37 in a first position, the receiving position, by the compartment 39 present there. This compartment 39 is moved to a second position, the metering position, and the compartment 38 located precisely at that point is moved into the receiving position, which then sends a previously emptied cartridge 7 pneumatically back to the loading place 27. The paint application device 4 in a defined high-voltage area 8 is placed under a high voltage corresponding to the painting method. A metering device 51 uses the paint and the cartridge 7 is emptied in a controlled manner as long as a painting operation lasts. During the painting operation, a car body 45 is moved into the high-voltage area 8 by the conveying system 49 of the workpieces to be painted. The car body 45 is painted and then transported out of the high-voltage area 8 again. The cartridges 7 are filled in accordance with the paint task and, consequently, are empty or virtually empty at the end of the painting operation. In order to be able to reuse the color residues which have remained in the paint line between metering device 51 and spray head 41, these residues are conveyed back into the cartridge 7 after the end of the painting operation, for example by a scraper device. The cartridge 7 with the color residue in the compartment 39 is then moved out of the metering position back into the receiving position and from there is moved pneumatically to the loading place 27 of the loading station 2. The method steps for cartridges 7 in the other receiving stations 37 are provided accordingly.

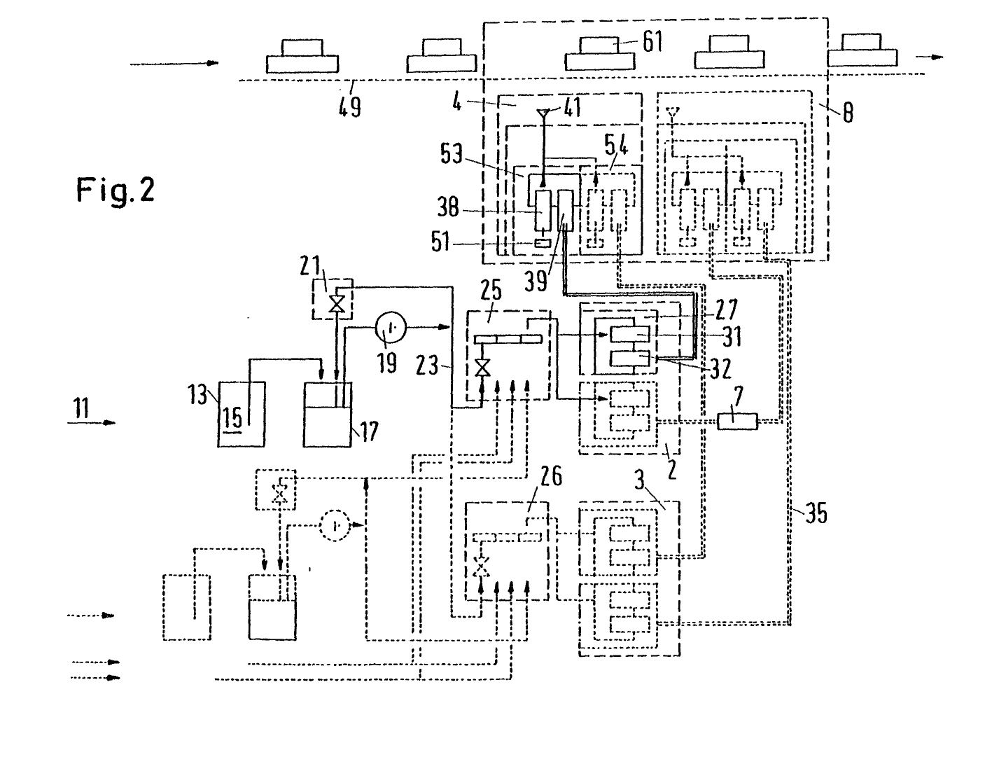

FIG. 2 shows a schematic diagram of a further configuration of a configuration of a pneumatic transport system for paint for painting workpieces. The delivery 11 of paint is carried out in containers 13 with paint of different colors 15. The paints delivered are taken from the containers 13 into circulation tanks 17 allocated to the colors 15 and initially stored there. In each case a circulation line is connected to each of these circulation tanks 17. The stored paint is conveyed out of the associated circulation tank 17 as required through the use of a pump 19 allocated to each circulation line, and, through the circulation line and via a throttling element 21 in the circulation line, is pumped back into the same circulation tank 17. From each of the circulation lines, a branch line 23 in each case leads to two color-change blocks 25, 26, which in each case has, on the inlet side, at least as many shut-off elements as there are branch lines 23 connected. On the outlet side, each color-change block 25, 26 is connected via an appropriately branched line to two loading stations 2, 3. The containers 13, the circulation tanks 17, the color-change blocks, 25, 26, the loading stations 2, 3 and the associated pipelines and other parts of the system and components are provided in a color-mixing room 5. The configuration of each loading station 2, 3 corresponds to the loading station 2 from FIG. 1. Since there are two loading stations 2, 3, each receiving station 37 is equipped with two places 53, 54 in each case. Each first place 53 is connected by a pipe in the pipe system 35 to a loading place of the first loading station 2, and each second place 54 is connected by a pipe in the pipe system 35 to a loading place of the second loading station 3. Each place 53, 54 in the loading stations 37 is thus configured like a space in a receiving station 37 in FIG. 1, that is to say is also, for example, equipped with two compartments in each case. The respective two places 53, 54 of each receiving station 37 are connected to each other in such a way that they can be operated alternately in order to save time when receiving and dispatching cartridges 7.

A conveyor system 49 transports workpieces 61 in the same way as described for the car bodies 43, 44, 45, 46, 47 in FIG. 1.

The individual steps of the method proceed like the method steps previously described in FIG. 1, but with the following additions and/or changes.

A control device coordinates the operations of the color-change blocks 25, 26 in such a way that the latter in each case alternately connect colors through to the two loading stations 2, 3 when a color change has to take place. The control device also ensures th at filled cartridges 7 are dispatched through the pipe system 35 from the loading stations 2, 3 alternately to the places 53, 54 of the receiving stations 37. Optimizing the time of the operations of the paint application devices 4 is performed by a control system belonging to the paint application device 4.

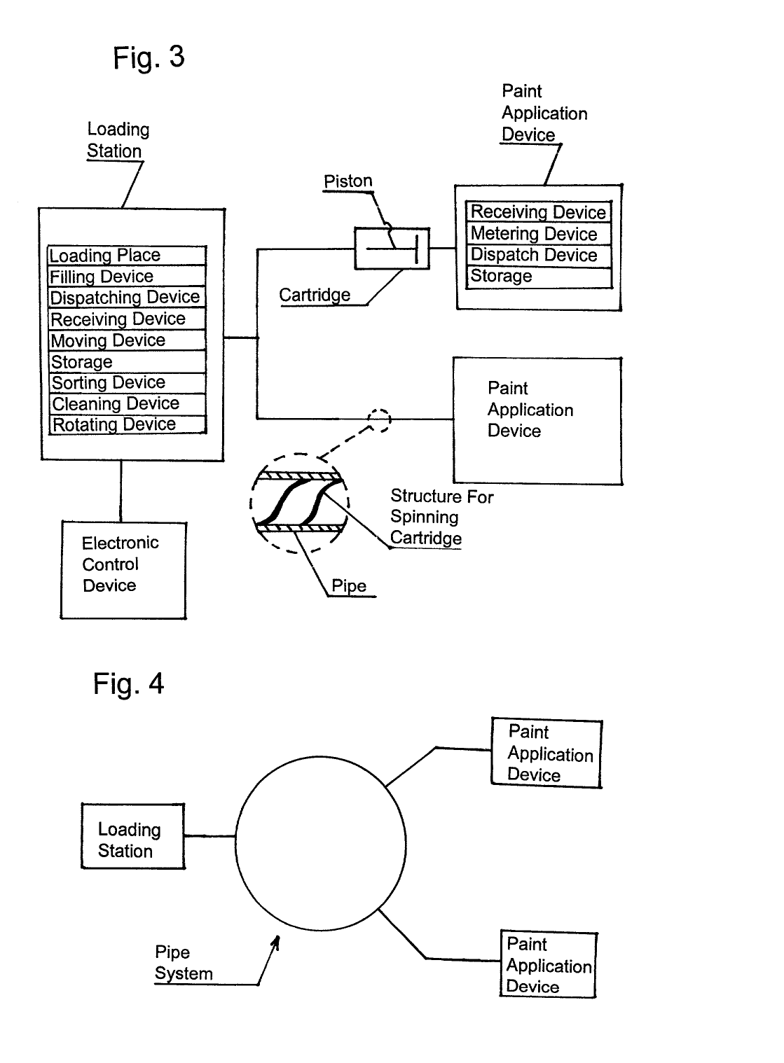

FIG. 3 illustrated a block diagram of a transport system with a branched pipe system according to the invention. The loading station includes a schematically illustrated loading place connected to the pipe system, a filling device for filling cartridges with paint, a dispatching device for dispatching the cartridges, a receiving device for receiving at least partly emptied cartridges, a moving device for moving the cartridges to and from the loading place, a storage for storing filled cartridges, a sorting device for sorting the cartridges, a cleaning device for cleaning the empty or partially emptied cartridges, and a rotating device for rotating or moving the cartridges in order to prevent a sedimentation of the paint in the cartridges.

The loading station is connected, via a branched pipe system, to two paint application devices. The paint application devices each include a schematically illustrated receiving device for receiving filled cartridges, a metering device for metering paint, a dispatch device for dispatching at least partly emptied cartridges, and a storage for storing cartridges.

The cartrides each include a piston which is movable in the cartridges for matching a paint volume in the cartridge. FIG. 3 further shows a detail of the pipe system which has inner surfaces with structures for spinning the cartridges when being conveyed through the pipe system for preventing sedimentation of the paint. An electronic control device for controlling the paint transport is connected to the loading station.

FIG. 4 illustrates a transport system with a ring pipe system according to the invention.

We claim:

1. A method of transporting electrically conductive paint, the method which comprises:
filling a required quantity of an electrically conductive paint into a cartridge at a location at ground potential, the location at ground potential serving as a loading station;
pneumatically conveying the cartridge filled with the electrically conductive paint through an at least partly electrically insulating pipe system to a paint application device at a high potential;
connecting, at the paint application device, the cartridge to a spray head provided at the paint application device;
pneumatically conveying the cartridge back to the location at ground potential, when the cartridge is at least partly emptied;
filling a further cartridge at the location at ground potential; and
subsequent to receiving an at least partly emptied cartridge at the location at ground potential, conveying the further cartridge to the paint application device.

2. The method according to claim 1, which comprises filling the further cartridge at the location at ground potential while pneumatically conveying the cartridge back to the location at ground potential, when the cartridge is at least partly emptied.

3. The method according to claim 1, which comprises:
providing a further paint application device, the paint application device and the further paint application device having respectively different addresses and being connected to the at least partly electrically insulating pipe system;
conveying filled cartridges from the loading station to the paint application device and the further paint application device; and
conveying at least partly emptied cartridges from the paint application device and the further paint application device back to the loading station.

4. The method according to claim 1, which comprises:
filling cartridges at at least two loading stations and providing each of the cartridges with a respective unique address;
providing a further paint application device, the paint application device and the further paint application device having respectively different addresses and being connected to the at least, partly electrically insulating pipe system;
conveying filled cartridges from the at least two loading stations to the paint application device and the further paint application device; and
conveying at least partly emptied cartridges from the paint application device and the further paint application device back to the at least two loading stations.

5. A configuration for transporting electrically conductive paint, comprising:
a loading station configured for loading cartridges to be used for transporting paint, said loading station being a location at ground potential;
a paint application device at a high potential;
a pipe system connected to said location at ground potential and to said paint application device, said pipe system being at least partly configured as an electrically insulating system;
a compressed-air conveying device for pneumatically conveying the cartridges; and
an electronic control device, operatively connected to at least one of said loading station and said paint application device, for at least partly controlling a paint transport.

6. The configuration according to claim 5, including:
a further paint application device at a high potential;
said pipe system having a connection end and having a pipe branch with ends;
said loading station being connected to said connection end of said pipe system; and
said paint application device and said further paint application device being connected to said ends of said pipe branch.

7. The configuration according to claim 5, including:
a further paint application device at a high potential;
said pipe system being a ring line having pipe branches with ends; and
said loading station, said paint application device, and said further paint application device being connected to said ends of said pipe branches.

8. The configuration according to claim 5, including:
a further paint application device at a high potential;
said pipe system including two pipelines having respective first ends and respective second ends;
said loading station being connected to said first ends of said two pipelines; and
said paint application device and said further paint application device respectively being connected to said second ends of said two pipelines.

9. The configuration according to claim 5, wherein said pipe system is a pipeline configured as a one-piece-pipeline between said loading station and said paint application device.

10. The configuration according to claim 6, wherein said pipe system includes a pipeline configured as a one-piece-pipeline between said loading station and said pipe branch.

11. The configuration according to claim 5, wherein said loading station has a loading place connected to said pipe system and devices for filling the cartridges with paint, for pneumatically dispatching the cartridges, for receiving at least partly emptied cartridges, and for moving the at least partly emptied cartridges from said loading place.

12. The configuration according to claim 11, including a further loading place identical to said loading place, said loading place and said further loading place selectively being operable in parallel and independently of one another.

13. The configuration according to claim 5, including:
further paint application devices;
said loading station having a given number of identical loading places, the given number corresponding to a total number of said paint application devices; and
said loading places selectively being operable in parallel and independently of one another.

14. The configuration according to claim 5, wherein said loading station has devices for storing filled cartridges, for sorting filled cartridges, for cleaning at least partly emptied cartridges, for testing cartridges for damage, for conveying residual paint back into an associated line, and for one of rotating and moving cartridges in order to prevent sedimentation of the paint.

15. The configuration according to claim 5, wherein said paint application device has a receiving station with at least one place connected to said pipe system, and devices for receiving filled cartridges, for metering paint, for guiding paint through a line system to a spray head, and for pneumatically dispatching at least partly emptied cartridges.

16. The configuration according to claim 15, wherein said receiving station has two places connected to said pipe system such that said two places can be operated independently of one another.

17. The configuration according to claim 15, wherein said paint application device additionally has devices for storing cartridges, for refilling cartridges with residual paint, and for one of rotating and moving cartridges in order to prevent sedimentation of the paint.

18. The configuration according to claim 5, wherein said pipe system includes pipes, at least some of said pipes are formed of an electrically insulating material.

19. The configuration according to claim 5, wherein said pipe system includes at least a first pipe formed of an electrically insulating material and connected to said paint application device at the high potential, and said pipe system includes at least a second pipe made of a metallic material.

20. The configuration according to 5, wherein said pipe system has inner surfaces configured for spinning the cartridges when being conveyed through said pipe system for preventing sedimentation of the paint.

21. The configuration according to claim 5, wherein said electronic control device is an automatic control device for coordinating a paint selection, color sequences, and operations of at least one of said loading station and said paint application device, and said compressed-air conveying device.

22. The configuration according to claim 5, wherein said electronic control device operates based on a fuzzy logic.

23. The configuration according to claim 5, wherein said electronic control device takes into account service lives of paints of different colors in respective cartridges and optimizes an operation sequence based on the service lives.

24. The configuration according to claim 5, wherein said electronic control device is a component in an overall control device for supplying the paint.

25. The configuration according to claim 5, wherein said electronic control device is configured for performing an overall control.

26. The configuration according to claim 5, wherein said electronic control device learns and adapts parameters automatically based on operating data collected and evaluated during an operating time.

27. A configuration for transporting electrically conductive paint, comprising:
cartridges for transporting paint, said cartridges having respective pistons, said pistons being movable to respective positions in said cartridges for matching respective paint volumes in said cartridges;
a loading station configured for loading said cartridges, said loading station being a location at ground potential;
a paint application device at a high potential;
a pipe system connected to said location at ground potential and to said paint application device, said pipe system being at least partly configured as an electrically insulating system;
a compressed-air conveying device for pneumatically conveying said cartridges; and
an electronic control device, operatively connected to at least one of said loading station and said paint application device, for at least partly controlling a paint transport.
